(19) United States
(12) Patent Application Publication
(10) Pub. No.: US 2009/0312148 A1
(43) Pub. Date: Dec. 17, 2009

(54) Brake Force Generating Device for a Hydraulic Vehicle Brake System, Vehicle Brake System and Method for Operating a Brake Force Generating Device

(76) Inventors: Peter Schlüter, Boppard (DE); Frank Schlüter, Boppard (DE); Alexander Schlüter, Kammerforst (DE); Stefan Schlüter, Kammerforst (DE); Irina Gerdt, Kammerforst (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/086,793

(22) PCT Filed: Dec. 8, 2006
(86) PCT No.: PCT/EP2006/011844

§ 371 Date: Nov. 24, 2008

(30) Foreign Application Priority Data
Dec. 22, 2005 (DE) 10 2005 061 598.8

(51) Int. Cl. B60T 8/32; B60T 13/72

(52) U.S. Cl. 477/182; 303/12

(57) ABSTRACT

The invention relates to a brake force generating device for a hydraulic vehicle brake system with a force input member, which can be or is coupled to a brake pedal, a master cylinder arrangement for generating a hydraulic brake pressure, a chamber arrangement, in which a working chamber is separated from a vacuum chamber via a movable wall, a control valve device with a control valve housing for optional connection of the vacuum chamber to the working chamber or of the working chamber to the atmosphere and an electrically triggerable actuating device for actuating the control valve device, which is positioned as floating in the control valve housing. According to the invention it is provided that the control valve device has a first seal seat and a second seal seat, the seal seats being arranged on opposite sides of the actuating device in respect of the longitudinal axis. The invention provides that in a normal operating situation the force input member is mechanically uncoupled from the control valve device actuated by the actuating device. In an emergency operating situation, however, the force input member can according to the invention be coupled mechanically to the control valve device and can actuate the control valve device as a result of its displacement in the direction of the longitudinal axis.

### CROSS-REFERENCE TO RELATED APPLICATIONS

This application is the National Stage of International Application No. PCT/EP2006/011844 filed Dec. 8, 2006, the disclosures of which are incorporated herein by reference in their entirety, and which claimed priority to German Patent Application No. 10 2005 061 598.8 filed Dec. 22, 2005, the disclosures of which are incorporated herein by reference in their entirety.

### BACKGROUND OF THE INVENTION

The present invention relates to a brake force generating device for a hydraulic vehicle brake system with a force input member, which is displaceable along a longitudinal axis and is or can be coupled to a brake pedal, a chamber arrangement, in which a working chamber is separated from a vacuum chamber via a movable wall, a control valve device with a control valve housing, the control valve device having a first seal seat for optional connection of the vacuum chamber to the working chamber and a second seal seat for optional connection of the working chamber to the atmosphere, an electrically triggerable actuating device, positioned as floating in the control valve housing, for actuating the control valve device and a master cylinder arrangement for generating a hydraulic brake pressure, the first seal seat being arranged on one side of the actuating device and the second seal seat being arranged on the opposite side of the actuating device in respect of the longitudinal axis.

Brake force generating devices of this kind are known from the prior art. For example, document DE 198 02 847 C2 of the applicant shows a pneumatic brake booster of the initially described kind. Also provided with this brake booster is an actuating device triggerable according to the actuation of the force input member, in particular a magnetic coil and armature arrangement. As a result of a displacement of the force input member, in this prior art the magnetic coil is triggered, whereupon an actuating sleeve coupled to a magnetic armature is displaced to open and close the control valve device.

However, it has been proved that with this arrangement fundamentally each actuation of the brake pedal which entails a displacement of the force input member is immediately converted into an actuation of the control valve device. This is due in particular to the direct mechanical coupling of force input member and valve seat. In other words, by his actuation action on the brake pedal, certainly when using the brake booster, the driver influences the hydraulic pressure on the wheel brakes. All the time the intervention of the driver supports the braking situation this is not a problem. But as soon as the driver reacts incorrectly related to the actual braking situation by, for example, triggering too much or too little brake pressure, the braking behaviour, in particular the vehicle's stopping distance and ability to keep to the right lane may be impaired, which in the worst case may lead to an accident.

Modern vehicle control systems (ABS, ESP, TC, etc.) are these days capable of detecting the optimum necessary brake power within the physical limits using the current driving state of the vehicle, thus optimising braking. However, a precondition for this is that the above-mentioned direct influencing of the brake pressure by the driver is then prevented. It is meanwhile further also regarded as inconvenient that the driver should feel the effect of the vehicle control system on the brake pedal, such as, for example, repeated shaking on the brake pedal when activating an anti-blocking system.

### BRIEF SUMMARY OF THE INVENTION

It is a feature of the present invention to provide a brake force generating device of the initially described kind, which enables reliable mechanical uncoupling of the brake force generation from the mechanically actuated brake pedal, but which allows adequate brake force generation in an emergency operating situation by immediate employment of the actuating force generated on the brake pedal.

This feature is achieved by a brake force generating device of the initially described kind, in which it is further provided that the force input member is mechanically uncoupled from the control valve device actuated by the actuating device during a normal operating situation and that in an emergency operating situation, in the event of failure of the actuating device, the force input member, as a result of its displacement in the direction of the longitudinal axis to actuate the control valve device, can be mechanically coupled thereto.

According to the invention the force input member can therefore be completely mechanically uncoupled from the rest of the brake force generating device in a normal operating situation, so that the driver does not feel sequences for generating a brake force in the brake force generating device directly on the brake pedal. Furthermore, displacements of the force input member arising from a brake pedal actuation do not lead immediately and necessarily to corresponding brake force generation. Instead, electronic control systems which monitor the braking process, may induce only moderate brake force generation, as a function of further parameters, such as, for example, the nature of the road surface or such, in spite of very intensive brake pedal actuation, uncoupled from the brake pedal, for example precisely as is sensible within the physical and driving-dynamics limits of the present operating state.

However, if in an emergency operating situation individual components of the brake system fail, for example the electronic control device for triggering the brake force generating device, it is further possible that in such an emergency operating situation an adequately great braking effect is achieved by immediate use of the brake force applied by the driver on the brake pedal. The present brake force generating device therefore provides a kind of fall-back level for the event of the emergency operating situation described above.

Moreover, it can be ascertained that the brake force generating device according to the invention can be exceptionally compactly configured owing to its design with seal seats arranged on both sides of the actuating device. This applies in particular to the construction space in the radial direction. Unlike with conventional brake force generating devices, in which the two seal seats are arranged in succession in the radial direction in respect of the longitudinal axis and thus have a “dish-like” construction, with the invention the two seal seats can be arranged at different points of the brake force generating device seen in the direction of the longitudinal axis, thus saving radial construction space. The construction space required in the direction of the longitudinal axis on the other hand is increased only negligibly.

A further development of the invention provides that the control valve housing is coupled to the movable wall. According to the invention it is possible further to provide a shift piston which can be coupled to the force input member via a stop in the emergency operating situation, the shift piston being designed for mechanical actuation of the control valve device when coupled to the force input member.

The shift piston can at the same time be biased in an initial position relative to the control valve housing by a piston restoring spring. The shift piston may be arranged in such a way that it is located at a defined distance s from the stop in a non-actuated state of the brake force generating device. Advantageously the distance s is in this case of greater dimensions than the path covered by the force input member relative to the control valve housing in a normal operating situation.

In an emergency operating situation, if for example the vehicle electronics for triggering the brake force generating device have failed, with an adequately strong pedal actuation according to the invention the force input member is displaced relative to the control valve housing, so that it surmounts the distance s. Finally, the stop acts on the shift piston in such a way that it actuates the control valve device mechanically.

The fact that in a normal operating situation the distance s between the stop and the shift piston is not surmounted guarantees that the displacement of the force input member caused by a brake pedal actuation by the driver does not have any direct effect on the brake force generation by the brake force generating device according to the invention, since mechanical coupling between the force input member and the control valve device is prevented. In an emergency operating situation on the other hand a mechanical coupling of this kind takes place after the distance s has been passed through and braking with adequate brake force is enabled.

According to a further embodiment the invention provides that the actuating device has a first actuating element, displaceable in the control valve housing, and a second actuating element, the second actuating element being displaceable relative to the first actuating element. This enables a compact design of the arrangement according to the invention, which will be described more clearly below.

The first actuating element may, for example, comprise a magnetic coil and the second actuating element a magnetic armature, the magnetic coil and magnetic armature each being assigned to a different seal seat. The magnetic coil is here advantageously coupled to a magnetic coil housing positioned as floating in the control valve housing and the magnetic armature is connected to an actuating sleeve. As already mentioned above, the magnetic armature and the magnetic coil are displaceable in respect of one another. Thus a single pair consisting of magnetic coil and magnetic armature can be used to open and close two seal seats, which in comparison to normal use of one magnetic coil and magnetic armature pair per seal seat in each case entails less space requirement.

Preferably, according to the invention the magnetic coil housing is designed as an actuating element for the first seal seat, while the actuating sleeve is designed as actuating element for the second seal seat.

In order to convey to the driver a familiar “pedal feeling” in spite of the mechanical uncoupling of the force input member from the control valve device and therefore from the brake force generation in a normal operating situation, the force input member may be able to be coupled to a pedal counterforce simulation device, as frequently used in modern vehicles. This may work purely mechanically, for example by compression of a spring arrangement, or/and hydraulically or pneumatically.

In a further embodiment of the invention a first valve element is assigned to the first seal seat and a second valve element to the second seal seat. They are biased in each case in the direction of the actuating device by a restoring spring. Advantageously the spring force of the restoring spring assigned to the first seal seat is dimensioned in such a way that it is less than the spring force of the restoring spring assigned to the second seal seat. This enables simple and compact configuration of the brake force generating device with simultaneously reliable running of the operating phases described below.

In a further embodiment of the invention it is provided that the force input member can be coupled to a transmission piston in a conventional way.

In the neutral position of the brake force generating device according to the invention the working chamber and the vacuum chamber are connected to one another by fluid and no brake force is applied to the master cylinder. If in a normal operating situation the driver now displaces the force input member by actuating the brake pedal, the actuating device is electrically triggered according to this displacement. The actuating element assigned to the second seal seat is in this case first moved in the direction of the second seal seat until an interaction arises between the second seal seat and the associated actuating element and the spring force of the assigned restoring spring prevents a further movement of the actuating element. With continuous electrical triggering a force is applied to the actuating element assigned to the first seal seat, which owing to this force moves in the direction of the first seal seat until the latter is closed and the connection between the working chamber and the vacuum chamber is disconnected. No further movement of the actuating element assigned to the first seal seat in the direction of the first seal seat is possible, so that now a power of recoil is generated, which acts on the actuating element assigned to the second seal seat in the direction of the second seal seat. This actuating element is displaced as a result of the power of recoil, so that the second seal seat is opened, whereby a connection is produced between the working chamber and the atmosphere or a pressure source. This generates a differential pressure between the working chamber and the vacuum chamber at the movable wall. According to this differential pressure the movable wall is displaced with the control valve housing, whereby ultimately a brake force is generated on to the master cylinder. If the differential pressure is sufficient for the necessary brake force, by electrical triggering of the actuating device its power supply can be reduced, so that the second seal seat closes again. A quasi-stationary state ensues, which ensures a brake force corresponding to the requirement defaulted by the brake pedal actuation or the vehicle control system.

As a result of release of the brake pedal the system moves back into its initial position, wherein the working chamber and the vacuum chamber are connected to one another, resulting in equalisation of pressure.

If in an emergency operating situation, for example owing to failure of the control electronics, the actuating device is unable to be triggered electrically according to the displacement of the force input member, a mechanical coupling of the force input member to the control valve device is produced, for example by a coupling between a stop and a shift piston. Owing to the continuing displacement of the force input member relative to the control valve housing after the coupling to the shift piston, the first seal seat is then closed and on further displacement of the force input member the second seal seat is opened, so that in the same way a pressure difference is formed between the working chamber and the vacuum chamber at the movable wall. By corresponding displacement of the control valve housing a brake force is transmitted to the master cylinder. When the brake pedal is released and the force input member is displaced back into its neutral position, the procedure is run through in the reverse direction, whereby the generation of a brake force is completed.

The invention also relates to a brake system for a motor vehicle which uses one of the embodiments of the brake force generating device described above.

Other advantages of this invention will become apparent to those skilled in the art from the following detailed description of the preferred embodiment, when read in light of the accompanying drawing.

### BRIEF DESCRIPTION OF THE DRAWING

FIG. 1 shows an axis-containing sectional view of a brake force generating device according to the invention.

### DETAILED DESCRIPTION OF THE INVENTION

In the figure a brake force generating device 10 with a brake force generating device housing 12 is illustrated, which is divided into a working chamber 16 and a vacuum chamber 18 by a movable wall 14. The vacuum chamber 18 is connected to a vacuum source, not shown. The working chamber 16 and the vacuum chamber 18 can be triggered via a control valve device 22, as will be explained in detail below.

The brake force generating device 10 further has a force input member 20, displaceable along a longitudinal axis A and coupled to a brake pedal, not shown. The force input member 20 is further connected to a transmission piston 24. The brake force generating device 10 is further connected to a master cylinder to transmit force, which is not shown in the figure.

The brake force generating device 10 has an electromagnetic actuating arrangement 26, comprising a magnetic coil 28 and a magnetic armature 30. The magnetic coil 28 is coupled to a magnetic coil housing 32. The magnetic armature 30 is arranged as displaceable relative to the magnetic coil housing 32 and rigidly connected to an actuating sleeve 34.

The magnetic coil housing 32 is positioned as floating in a control valve housing 36 of the control valve device 22, which is connected to the movable wall 14 and is displaceable in the housing 12 of the brake force generating device 10.

Arranged in the figure on the left of the actuating device 26 is a first control valve area 38. It comprises a seal seat 40 and a valve element 44, which is biased to the right in the figure via a restoring spring 42.

Arranged along the longitudinal axis A of the brake force generating device 10 on the opposite side of the actuating device 26 is a second control valve area 46. This comprises a seal seat 48 and a valve element 52, which is biased to the left in the figure via a restoring spring 50.

Restoring spring 50 is designed as stronger than restoring spring 42.

Formed on the transmission piston 24 is a shoulder-like stop 54, which is located in the neutral state shown in the figure at a distance s from a stop face 55 of a shift piston 56. The shift piston 56 is biased relative to the control valve housing 36 by a piston restoring spring 58 and is held back in the position shown in the figure by a backwards-facing stop step 60 against the bias of the piston restoring spring 58.

The brake force generating device 10 according to the figure additionally comprises several inlet holes 64, 66 and intermediate chambers 68, 70 which enable a fluid connection between the working chamber 16 and the vacuum chamber 18.

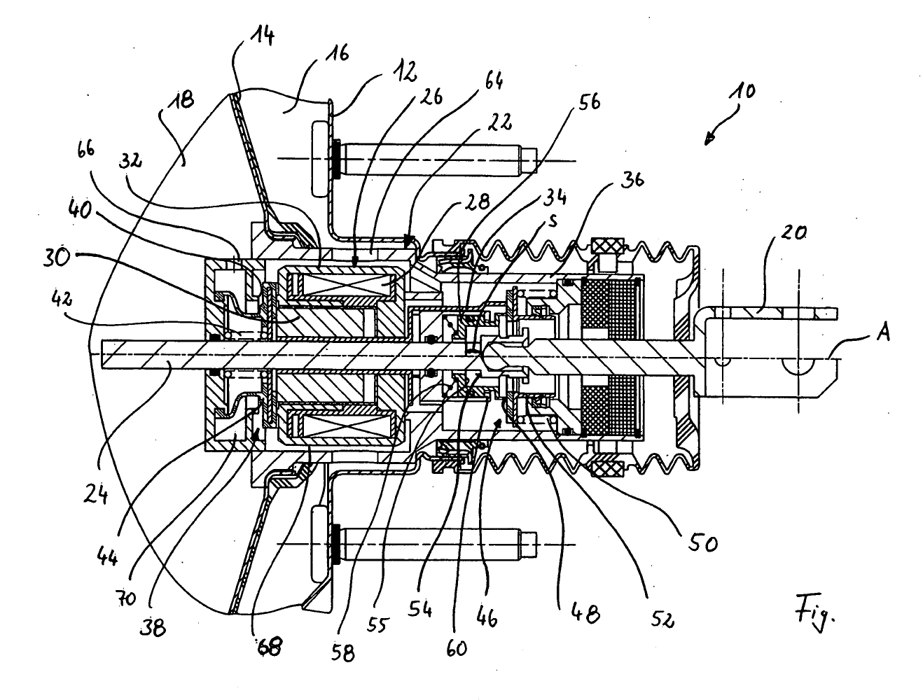

In a normal operating situation the brake force generating device 10 is actuated in a defined order. When the magnetic coil 28 is supplied with power magnetic forces are generated, which move the magnetic armature 30 and the actuating sleeve coupled thereto in the direction of valve element 52, in other words in FIG. 1 to the right, until it comes into contact with valve element 52 and is there firstly held back by the spring force of restoring spring 62. Since restoring spring 42 on valve element 44 is designed as weaker than restoring spring 50, a power of recoil acts on the magnetic coil housing 32, positioned as floating, and moves it to the left. The magnetic coil housing 32 now acts on valve element 44 and moves it to the left on to seal seat 40, so that this is closed. This separates the working chamber 16 from the vacuum chamber 18 and prevents the magnetic coil housing 32 from making a further movement to the left.

On further supply of power the magnetic armature 30 now also overcomes the spring force of restoring spring 50 and by means of the actuating sleeve 34 displaces valve element 52 to the right in the figure. As a result seal seat 48 opens, since the shift piston 56 is held back against the stop step 60. When seal seat 48 is opened the working chamber 16 is connected to the atmosphere. This causes a differential pressure to arise at the movable wall 14, the control valve housing 36 is displaced correspondingly to the left and a brake force is generated in the master cylinder. By slight reduction of the power supply seal seat 52 can be closed again and the differential pressure thus held.

To suspend the brake effect the power supply is suspended completely and the sequences described above are performed in the reverse order, until there is complete pressure equalisation at the movable wall 14 and a return of the arrangement into the initial state shown in the figure.

During a normal operating situation of this kind the distance s between the stop 54 and the shift piston 56 is not surmounted and the transmission piston 24 connected to the force input member 20 does not arrive at mechanical contact with the control valve device 36.

In an emergency operating situation, e.g. if the power supply of the vehicle fails, the brake force generating device 10 is immediately actuated by the displacement of the force input member 20. At the same time because of the displacement of the force input member 20 the distance s between the stop 54 and the shift piston 56 is reduced until a mechanical coupling of the transmission piston 24 to the shift piston 56 and therefore of the control valve device 36 has been achieved. On further displacement of the force input member 20 the shift piston 56 is moved along against the spring force of the piston restoring spring 58, whereby restoring spring 50 is relieved of pressure and has a surplus of force compared with restoring spring 42. This surplus of force leads to the magnetic coil housing 32 being displaced to the left and closing seal seat 40. If the force input member 20 is now moved further, the entrained shift piston 56 opens seal seat 40 and thus connects the working chamber 16 to the atmosphere. In this way, as described above, a differential pressure is generated at the movable wall 14, which ultimately leads to brake force generation via the master cylinder.

By the invention it is also possible, with a compactly produceable brake force generating device 10 with control valve areas 38 and 46 arranged on both sides of the actuating device 26 with respective seal seats 40 and 48 to achieve mechanical uncoupling of the force input member and control valve device 22.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Brake force generating device for a hydraulic vehicle brake system with
a force input member which is displaceable along a longitudinal axis and can be or is coupled to a brake pedal,
a chamber arrangement, in which a working chamber is separated from a vacuum chamber via a movable wall,
a control valve device with a control valve housing, the control valve device having a first seal seat for optional connection of the vacuum chamber to the working chamber and a second seal seat for optional connection of the working chamber to the atmosphere, and
an electrically triggerable actuating device, positioned as floating in the control valve housing for actuating the control valve device,
wherein the first seal seat is arranged on one side of the actuating device and wherein the second seal seat is arranged on the opposite side of the actuating device in respect of the longitudinal axis, and
wherein in a normal operating situation the force input member is mechanically uncoupled from the control valve device actuated by the actuating device and that in an emergency operating situation, in the event of failure of the actuating device the force input member, as a result of its displacement in the direction of the longitudinal axis to actuate the control valve device, can be mechanically coupled thereto.

2. Brake force generating device according to claim 1, wherein the control valve housing is coupled to the movable wall.

3. Brake force generating device according to claim 1, wherein a shift piston which can be coupled to the force input member via a stop in the emergency operating situation, the shift piston being designed for mechanical actuation of the control valve device when coupled to the force input member.

4. Brake force generating device according to claim 3, wherein the shift piston is biased into an initial position relative to the control valve housing by a piston restoring spring.

5. Brake force generating device according to claim 3, wherein in a non-actuated state of the brake force generating device the shift piston is arranged at a defined distance from the stop.

6. Brake force generating device according to claim 5, wherein the distance is of larger dimensions than a path covered relative to the control valve housing by the force input member in a normal operating situation.

7. Brake force generating device according to claim 5, wherein the force input member is displaced relative to the control valve housing in an emergency operating situation and after surmounting the distance acts on the shift piston for mechanical actuation of the control valve device.

8. Brake force generating device according to claim 1, wherein the actuating device has a first actuating element displaceable in the control valve housing and a second actuating element displaceable relative to the first actuating element.

9. Brake force generating device according to claim 8, wherein the first actuating element comprises a magnetic coil and in that the second actuating element comprises a magnetic armature, each actuating element being assigned in each case to a seal seat.

10. Brake force generating device according to claim 9, wherein the magnetic coil is coupled to a magnetic coil housing positioned as floating in the control valve housing.

11. Brake force generating device according to claim 10, wherein the magnetic coil housing is designed as an actuating element for the first seal seat.

12. Brake force generating device according to claim 9, wherein the magnetic armature is connected to an actuating sleeve, the actuating sleeve being designed as an actuating element for the second seal seat.

13. Brake force generating device according to claim 1, wherein it further comprises a pedal counterforce simulation device which can be or is coupled to the force input member.

14. Brake force generating device according to claim 1, wherein a first valve element is assigned to the first seal seat and in that a second valve element is assigned to the second seal seat, each valve element being biased in the direction of the actuating device in each case by a restoring spring.

15. Brake force generating device according to claim 14, wherein the spring force of the restoring spring assigned to the first seal seat is less than the spring force of the restoring spring assigned to the second seal seat.

16. Brake force generating device according to claim 1, wherein the force input member is coupled to a transmission piston.

17. Brake system for a motor vehicle with a brake force generating device used according to claim 1.

18. Method for operating a brake force generating device having a force input member which is displaceable along a longitudinal axis and can be or is coupled to a brake pedal, a chamber arrangement, in which a working chamber is separated from a vacuum chamber via a movable wall, a control valve device with a control valve housing, the control valve device having a first seal seat for optional connection of the vacuum chamber to the working chamber and a second seal seat for optional connection of the working chamber to the atmosphere, and an electrically triggerable actuating device, positioned as floating in the control valve housing for actuating the control valve device, wherein the first seal seat is arranged on one side of the actuating device and wherein the second seal seat is arranged on the opposite side of the actuating device in respect of the longitudinal axis, wherein in the normal operating situation the actuating device can be triggered according to the displacement of the force input member while the force input member and the control valve device are mechanically uncoupled,
(i) wherein the actuating sleeve is displaced relative to the control valve housing until it enters into interaction with the second seal seat,
(ii) wherein restoring spring assigned to the second valve element then counteracts a further displacement of the actuating sleeve,
(iii) wherein the magnetic coil housing then moves against the restoring force of restoring spring assigned to the first valve element relative to the control valve housing, whereby the first seal seat is closed and the connection between the working chamber and the vacuum chamber therefore disconnected,
(iv) wherein the magnetic armature then moves the actuating sleeve against the restoring force of restoring spring assigned to the second valve element and opens the second seal seat, thus producing a connection between the working chamber and the atmosphere, so that a differential pressure forms between the working chamber and the vacuum chamber at the movable wall.

19. Method according to claim 18, wherein in an emergency operating situation in which the actuating device cannot be triggered according to the displacement of the force input member,
(i) as a result of a displacement of the force input member the distance s is passed through, so that a mechanical coupling arises between the stop and the shift piston,
(ii) wherein the shift piston is then displaced against the restoring force of the piston restoring spring with the force input member relative to the control valve housing,
(iii) wherein the first seal seat then closes as a result of relief of pressure of restoring spring assigned to the second valve element,
(iv) wherein as a result of a further displacement of the force input member the second seal seat is then opened by entraining of the shift piston, so that a pressure difference is formed between the working chamber and the vacuum chamber at the movable wall.
